(19) United States
(12) Patent Application Publication
(10) Pub. No.: US 2020/0145985 A1
(43) Pub. Date: May 7, 2020

(54) METHOD AND DEVICE FOR RECEIVING INFORMATION IN WIRELESS COMMUNICATION SYSTEM

(71) Applicant: LG ELECTRONICS INC., Seoul (KR)

(72) Inventors: Gwanmo KU, Seoul (KR); Sangrim LEE, Seoul (KR); Hojae LEE, Seoul (KR); Daewook BYUN, Seoul (KR); Sangwook HAN, Seoul (KR)

(73) Assignee: LG ELECTRONICS INC., Seoul (KR)

(21) Appl. No.: 16/609,008

(22) PCT Filed: Sep. 18, 2017
(86) PCT No.: PCT/KR2017/010174

§ 371 Date: Oct. 28, 2019

Related U.S. Application Data
(60) Provisional application No. 62/503,904, filed on May 9, 2017.

(51) Int. Cl. H04W 72/04; H04W 72/08; H04W 72/00; H04L 5/00

(52) U.S. Cl. CPC H04W 72/0413; H04L 5/0057; H04W 72/005; H04W 72/082

(57) ABSTRACT

According to an embodiment of the present specification, a method for receiving information by a base station in a wireless communication system may be provided. A method for receiving information by a base station may comprise the steps of: acquiring minimum transmission rate information for a function value of a first function; determining a parameter for minimizing distortion between a plurality of terminals; transmitting information on the first function to the plurality of terminals on the basis of the determined parameter; receiving, from the plurality of terminals, feedback information encoded on the basis of the function value; and decoding the encoded feedback information.

### TECHNICAL FIELD

The present disclosure relates to a wireless communication system, and more particularly, to a method and apparatus for receiving information at a receiver.

### BACKGROUND ART

Wireless communication systems have been widely deployed to provide various kinds of communication services such as voice and data services. Generally, these communication systems are multiple access systems capable of supporting communication with multiple users by sharing available system resources (e.g., bandwidth and transmission power). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency-division multiple access (SC-FDMA) system, and a multi-carrier frequency division multiple access (MC-FDMA) system.

### DISCLOSURE

### Technical Problem

An aspect of the present disclosure is to provide a method of receiving information at a receiver in a wireless communication system.

Another aspect of the present disclosure is to provide a method of reducing the amount of transmitted information in consideration of a relationship between pieces of information transmitted by transmitters.

Another aspect of the present disclosure is to provide a method of performing practical encoding and decoding to reduce the amount of transmitted information.

### Technical Solution

In an aspect of the present disclosure, a method of receiving information by a base station (BS) in a wireless communication system includes obtaining minimum transmission rate information for a function value of a first function, determining a parameter minimizing distortion between a plurality of user equipments (UEs), transmitting information about the first function based on the determined parameter to the plurality of UEs, receiving feedback information encoded based on the function value from the plurality of UEs, and decoding the encoded feedback information.

In another aspect of the present disclosure, a BS for receiving information in a wireless communication system includes a reception module configured to receive a signal, a transmission module configured to transmit a signal, and a processor configured to control the reception module and the transmission module. The processor is configured to obtain minimum transmission rate information for a function value of a first function, determine a parameter minimizing distortion between a plurality of UEs, transmit information about the first function based on the determined parameter to the plurality of UEs, receive feedback information encoded based on the function value from the plurality of UEs, and decode the encoded feedback information.

The following may be applied commonly to the method and apparatus for receiving information in a wireless communication system.

The minimum transmission rate information may be determined based on a rate distortion curve.

When the plurality of UEs transmit the feedback information, the rate distortion curve may be information indicating a minimum transmission rate for the function value of the first function in consideration of the distortion between the plurality of UEs.

The distortion between the plurality of UEs may be minimized through a functional distributed quantizer.

When the functional distributed quantizer is applied, a quantizer may be configured for use in each of the plurality of UEs, and the distortion may be minimized in consideration of an interval of the quantizer configured in each of the plurality of UEs.

The feedback information may be encoded based on the quantizer, and the encoded feedback information may be decoded based on a Bayes detector.

The parameter may be determined based on the quantizer.

The information about the first function may include at least one of a function index or an encoding index.

Encoding and decoding configuration information for the first function may be transmitted in system information to the plurality of UEs.

The feedback information may be channel quality indicator (CQI) feedback information, and the first function may be an argmax function.

### Advantageous Effects

The present disclosure may provide a method of receiving information at a receiver in a wireless communication system.

The present disclosure may provide a method of reducing the amount of transmitted information in consideration of a relationship between pieces of information transmitted by transmitters.

The present disclosure may provide a method of performing encoding and decoding to reduce the amount of transmitted information.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a block diagram illustrating the configurations of a base station (BS) 105 and a user equipment (UE) 110 in a wireless communication system 100;

FIG. 2 is a diagram illustrating a distributed functional compression method;

FIG. 3 is a diagram illustrating a rate region, when there is no distortion in distributed functional compression;

FIG. 4 is a diagram illustrating a rate region based on distributed function computation;

FIG. 5 is a diagram illustrating a bound based on distributed function computation;

FIG. 6 is a diagram illustrating an achievable bound based on an information theory;

FIG. 7 is a diagram illustrating distortion parts between a plurality of UEs;

FIG. 8 is a diagram illustrating a channel quality indicator (CQI) feedback method;

FIG. 9 is a diagram illustrating an achievable bound for an argmax function;

FIG. 10 is a diagram illustrating distorted parts for a plurality of UEs;

FIG. 11 is a diagram illustrating distortion regions based on quantization intervals;

FIG. 12 is a diagram illustrating overlap-caused distortion cases;

FIG. 13 is a diagram illustrating an achievable bound for an argmax function;

FIG. 14 is a diagram illustrating encoding and decoding schemes;

FIG. 15 is a diagram illustrating a method of reporting benefit metrics based on a coordinated multi-point (CoMP) operation;

FIG. 16 is a diagram illustrating a method of configuring a quantizer in benefit metric reporting;

FIG. 17 is a diagram illustrating an environment with a plurality of sensors;

FIG. 18 is a diagram illustrating a method of configuring a quantizer, when a plurality of sensors perform reporting;

FIG. 19 is a diagram illustrating a signal flow for a method of receiving information at an evolved Node B (eNB);

FIG. 20 is a flowchart illustrating a method of receiving information at a receiver; and

FIG. 21 is a flowchart illustrating a method of receiving information at a receiver.

### BEST MODE FOR CARRYING OUT THE INVENTION

Reference will now be made in detail to the preferred embodiments of the present disclosure, examples of which are illustrated in the accompanying drawings. In the following detailed description of the disclosure includes details to help the full understanding of the present disclosure. However, it is apparent to those skilled in the art that the present disclosure can be implemented without these details. For instance, although the following descriptions are made in detail on the assumption that a mobile communication system is the 3^{rd} generation partnership project (3GPP) long term evolution (LTE) system or long term evolution-advanced (LTE-A) system, the following descriptions are applicable to other random mobile communication systems by excluding unique features of the 3GPP LTE and LTE-A systems.

Occasionally, to prevent the present disclosure from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS) and the like. In addition, assume that a base station (BS) is a common name of such a random node of a network stage communicating with a terminal as a Node B (NB), an eNode B (eNB), an access point (AP) and the like.

In a mobile communication system, a UE can receive information from a BS in downlink and transmit information in uplink. The UE can transmit or receive various data and control information and use various physical channels depending types and uses of information transmitted or received thereby.

The following descriptions are applicable to various wireless access systems including a code division multiple access (CDMA) system, a frequency division multiple access (FDMA) system, a time division multiple access (TDMA) system, an orthogonal frequency division multiple access (OFDMA) system, a single carrier-frequency division multiple access (SC-FDMA) system, etc. CDMA can be implemented by radio technology such as universal terrestrial radio access (UTRA), CDMA 2000, etc. TDMA can be implemented with radio technology such as global system for mobile communications/general packet radio service/enhanced data rates for GSM evolution (GSM/GPRS/EDGE). OFDMA can be implemented with radio technology such as IEEE 802.11 (Wi-Fi), IEEE 802.16 (WiMAX), IEEE 802.20, evolved UTRA (E-UTRA), etc. UTRA is a part of universal mobile telecommunications system (UMTS).

3GPP LTE is a part of evolved UMTS (E-UMTS) using E-UTRA. The 3GPP LTE employs OFDMA in downlink (DL) and SC-FDMA in uplink (UL). In addition, LTE-A is an evolved version of the 3GPP LTE.

Moreover, in the following description, specific terminologies are provided to help the understanding of the present disclosure. In addition, the use of the specific terminology can be modified into another form within the scope of the technical idea of the present disclosure.

Regarding wireless transmission between a BS and a UE, transmission from a BS to a UE is defined as DL transmission, and transmission from a UE to a BS is defined as UL transmission. A mode where radio resources for DL transmission are different from those for UL transmission is referred to as ‘duplex mode’. In particular, a mode of performing transmission and reception bidirectionally by dividing time resources into DL transmission time resources and UL transmission time resources is referred to as ‘time division duplex (TDD) mode’, and a mode of performing transmission and reception bidirectionally by dividing frequency bands into DL transmission bands and UL transmission bands is referred to as ‘frequency division duplex (FDD) mode’. It is apparent that the technology proposed in the present disclosure may operate not only in the FDD mode but also in the TDD mode.

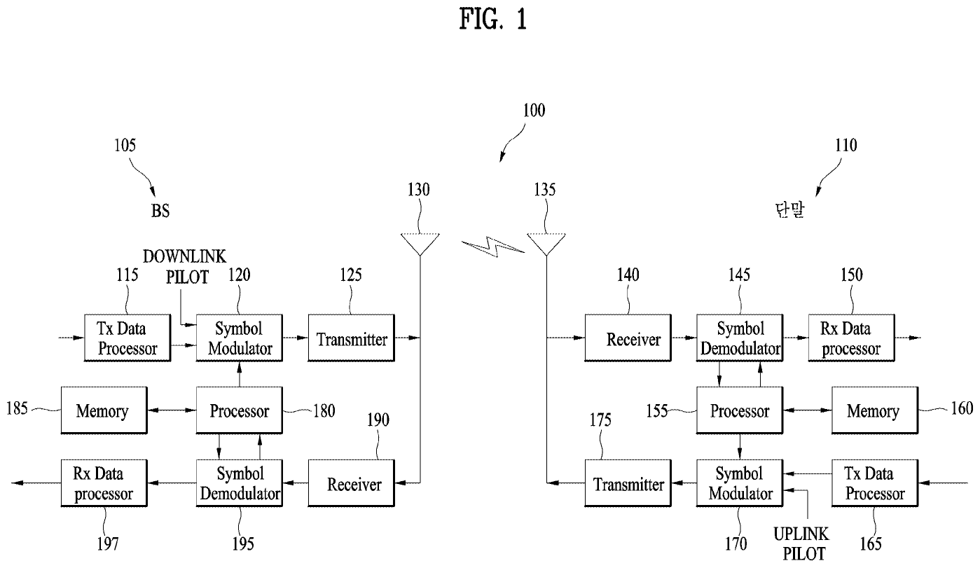

FIG. 1 is a block diagram illustrating configurations of a BS 105 and a UE 110 in a wireless communication system 100.

Although one BS 105 and one UE 110 are shown in the drawing to schematically represent the wireless communication system 100, the wireless communication system 100 may include at least one BSn and/or at least one UE.

Referring to FIG. 1, the BS 105 may include a transmission (Tx) data processor 115, a symbol modulator 120, a transmitter 125, a transmitting and receiving antenna 130, a processor 180, a memory 185, a receiver 190, a symbol demodulator 195, and a reception (Rx) data processor 197.

The UE 110 may include a Tx data processor 165, a symbol modulator 170, a transmitter 175, a transmitting and receiving antenna 135, a processor 155, a memory 160, a receiver 140, a symbol demodulator 155, and an Rx data processor 150. Although FIG. 1 shows that the BS 105 uses one transmitting and receiving antenna 130 and the UE 110 uses one transmitting and receiving antenna 135, each of the BS 105 and the UE 110 may include a plurality of antennas. Therefore, each of the BS 105 and the UE 110 according to the present disclosure can support the multi-input multi-output (MIMO) system. In addition, the BS 105 according to the present disclosure can also support both of the single user-MIMO (SU-MIMO) system and the multi-user-MIMO (MU-MIMO) system.

For DL transmission, the Tx data processor 115 receives traffic data, formats the received traffic data, codes the formatted traffic data, interleaves and modulates (or perform symbol mapping on) the coded traffic data, and provides modulated symbols (data symbols). The symbol modulator 120 provides a stream of symbols by receiving and processing the data symbols and pilot symbols.

The symbol modulator 120 performs multiplexing of the data and pilot symbols and transmits the multiplexed symbols to the transmitter 125. In this case, each of the transmitted symbols may be a data symbol, a pilot symbol or a zero value signal. In each symbol period, pilot symbols may be continuously transmitted. In this case, each of the pilot symbols may be a frequency division multiplexing (FDM) symbol, an orthogonal frequency division multiplexing (01-DM) symbol, or a code division multiplexing (CDM) symbol.

The transmitter 125 receives the symbol stream, converts the received symbol stream into one or more analog signals, adjusts the analog signals (e.g., amplification, filtering, frequency upconverting, etc.), and generates a DL signal suitable for transmission on a radio channel. Thereafter, the transmitting antenna 130 transmits the DL signal to the UE.

Hereinafter, the configuration of the UE 110 is described. The receiving antenna 135 receives the DL signal from the BS and forwards the received signal to the receiver 140. The receiver 140 adjusts the received signal (e.g., filtering, amplification, frequency downconversion, etc.) and obtains samples by digitizing the adjusted signal. The symbol demodulator 145 demodulates the received pilot symbols and forwards the demodulated pilot symbols to the processor 155 for channel estimation.

The symbol demodulator 145 receives a frequency response estimation value for DL from the processor 155, performs data demodulation on the received data symbols, obtains data symbol estimation values (i.e., estimation values of transmitted data symbols), and provides the data symbols estimation values to the Rx data processor 150. The Rx data processor 150 reconstructs the transmitted traffic data by demodulating (i.e., performing symbol demapping on), deinterleaving and decoding the data symbol estimated values. The processing performed by the symbol demodulator 145 and the Rx data processor 150 are complementary to that performed by the symbol modulator 120 and the transmission data processor 115 of the BS 105, respectively.

For UL transmission, the Tx data processor 165 of the UE 110 processes the traffic data and provides data symbols. The symbol modulator 170 receives the data symbols, performs multiplexing of the received data symbols, modulates the multiplexed symbols, and provides a stream of symbols to the transmitter 175. The transmitter 175 receives the symbol stream, processes the received stream, and generates an UL signal. The transmitting antenna 135 transmits the generated UL signal to the BS 105.

The BS 105 receives the UL signal from the UE 110 through the receiving antenna 130. The receiver 190 obtains samples by processing the received UL signal. Subsequently, the symbol demodulator 195 processes the samples and provides pilot symbols received in UL and data symbol estimation values. The Rx data processor 197 reconstructs the traffic data transmitted from the UE 110 by processing the data symbol estimation values.

The processor 155 of the UE 110 controls operations (e.g., control, adjustment, management, etc.) of the UE 110, and the processor 180 of the BS 105 controls operations (e.g., control, adjustment, management, etc.) of the BS 105. The processors 155 and 180 may be connected to the memory units 160 and 185 configured to store program codes and data, respectively. Specifically, the memory units 160 and 185, which are connected to the processors 155 and 180, respectively, store operating systems, applications, and general files.

Each of the processors 155 and 180 can be called a controller, a microcontroller, a microprocessor, a microcomputer or the like. In addition, the processors 155 and 180 can be implemented using hardware, firmware, software and/or any combinations thereof.

When the embodiments of the present disclosure are implemented using hardware, the processors 155 and 180 may be provided with application specific integrated circuits (ASICs), digital signal processors (DSPs), digital signal processing devices (DSPDs), programmable logic devices (PLDs), field programmable gate arrays (FPGAs), etc.

Meanwhile, when the embodiments of the present disclosure are implemented using firmware or software, the firmware or software may be configured to include modules, procedures, and/or functions for performing the above-explained functions or operations of the present disclosure. In addition, the firmware or software configured to implement the present disclosure is provided within the processors 155 and 180. Alternatively, the firmware or software may be saved in the memories 160 and 185 and then driven by the processors 155 and 180.

Radio protocol layers between a UE and a BS in a wireless communication system (network) may be classified as Layer 1 (L1), Layer 2 (L2), and Layer 3 (L3) based on three lower layers of the open system interconnection (OSI) model well known in communication systems. A physical layer belongs to the L1 layer and provides an information transfer service via a physical channel A radio resource control (RRC) layer belongs to the L3 layer and provides control radio resources between a UE and a network. That is, a BS and a UE may exchange RRC messages through RRC layers in a wireless communication network.

In the present specification, since it is apparent that the UE processor 155 and the BS processor 180 are in charge of processing data and signals except transmission, reception, and storage functions, they are not mentioned specifically for convenience of description. In other words, even if the processors 155 and 180 are not mentioned, a series of data processing operations except the transmission, reception, and storage functions can be assumed to be performed by the processors 155 and 180.

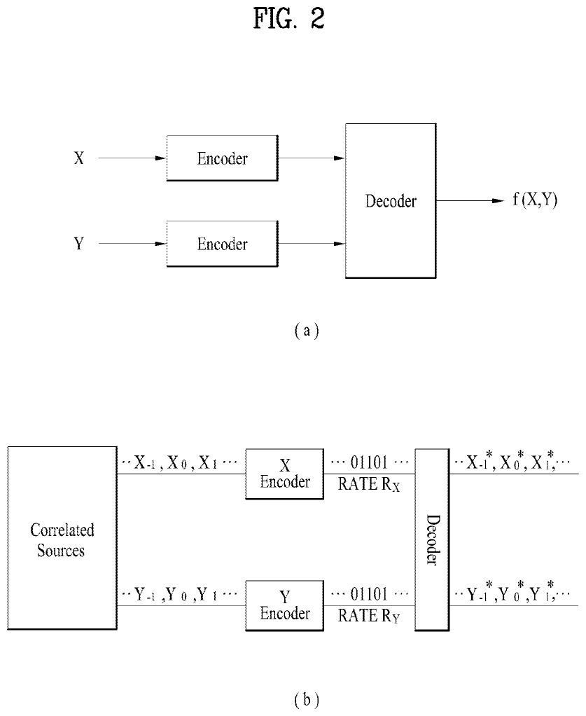

FIG. 2 is a diagram illustrating distributed functional compression. Referring to FIG. 2(a), X and Y may be encoded independently. Decoding may be performed on the assumption of zero distortion and an arbitrarily small probability of error. That is, a decoding function f(X, Y) may be computed with no regard to distortion and a probability error.

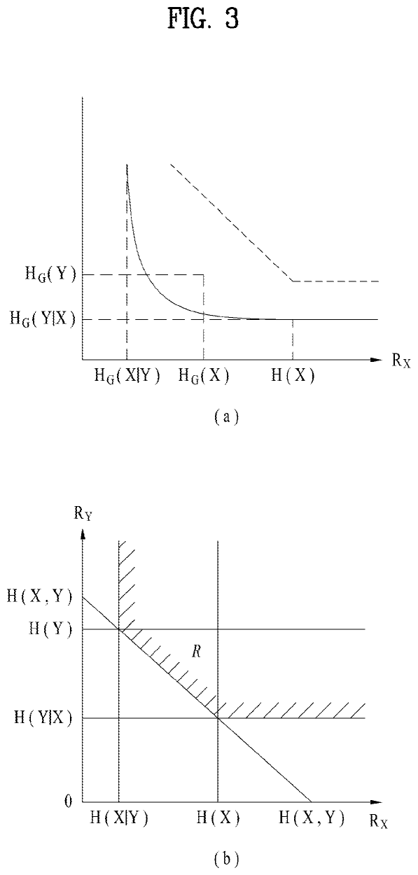

Referring to FIG. 2(b), for example, when distributed function compression is applied, encoders and a decoder for two correlated sources may be configured in a common information source. For example, the correlated information sequences may be . . . X₋₁, X₀, X₁ and . . . , Y₋₁, Y₀, Y₁ . . . , respectively. Each of these sequences may be obtained from a separate function p(x, y) with two variables. The encoder of each source may operate without knowledge of an operation of the other source. The decoder may perform decoding on a message stream for each source. Herein, the decoder may determine a minimum number of bits required to accurately reconfigure each information source based on the message stream. FIGS. 3(a) and 3(b) illustrate a rate region when there is no distortion in distributed function compression based on FIGS. 2(a) and 2(b) which have been described above.

A conventional source coding scheme may limit a compression rate in a source encoder based on the Shannon's source coding theorem. When a receiver is to perfectly recover information transmitted by a transmitter, like lossless source coding, the source encoder of the transmitter needs to encode the information at or above at least the entropy rate of the transmitted information.

For example, in addition to point-to-point communication involving one transmitter and one receiver, a communication system including a plurality of transmitters and a single receiver may be considered. Because information transmitted from each transmitter to the single receiver is regarded as an independent source, correlational/mutual information between the sources may be zero. Therefore, a transmission rate may not be reduced despite joint decoding of information related to distributed encoding.

However, when UL transmission involving a plurality of UEs and a single evolved Node B (eNB) is considered, distributed encoding and joint decoding of a function of interest at the eNB may be applied even to independent sources. Thus, only specific information related to the specific function may be transmitted and the transmission rate may be reduced. Herein, the transmission rate may be reduced by the above-described distributed function computation. However, a suitable encoding method for approaching a boundary region may become an issue even to distributed function computation, which will be described below.

For example, when an eNB receives channel information from each UE and performs resource allocation based on the received channel information in mobile communication, the above-described method of reducing a transmission rate may be applied. For example, when an individual UE is located at a cell edge, the method of reducing a transmission rate may also be applied in a coordinated multi-point (CoMP) scenario for interference management between eNBs. More specifically, the method of reducing a transmission rate may be applied, when feedbacks are received from a coordinate eNB and a center eNB and resource allocation is performed based on the feedbacks. An entity responsible for the resource allocation has only to estimate a function value for performing resource allocation as necessary information, rather than recover all of the received feedback information. That is, since transmission of only a specific function value of a resource allocation-related function is sufficient, the transmission rate may be reduced as described before.

For example, the receiver may provide achievable rate distortion information according to a function of interest. However, even though the achievable rate distortion information is known, there is a need for configuring an efficient encoding/decoding method for approaching a boundary region.

Now, a description will be given of an encoding/decoding scheme which is applied when the above-described boundary region is approached, in consideration of a communication system to which a feedback mechanism involving a plurality of transmitters and one receiver is applied.

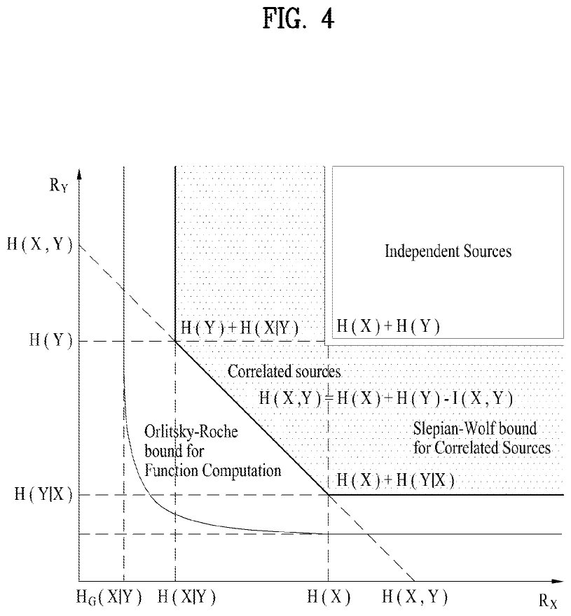

FIG. 4 is a diagram illustrating a rate region based on distributed function computation.

FIG. 4 illustrates a conventional source coding theorem in consideration of the above-described scheme. More specifically, according to the Shannon's source coding theorem, when a transmitter transmits information to a receiver and the receiver recovers the transmitted information, an encoder of the receiver should encode the information at least at the entropy rate of the information and transmit the encoded information to the receiver.

When a plurality of transmitters and a single receiver exist, the lower bound of information transmitted by the transmitters is determined according to the relationship between the information transmitted by the transmitters, as illustrated in FIG. 4. For example, the transmitters may transmit information source X and information source Y to the single receiver, respectively. Referring to FIG. 4, the plurality of transmitters (source X and source Y) should transmit information at least at a joint entropy (H(X, Y)) rate such that the receiver may perfectly recover the information of source X and source Y. For the correlated sources, as much of the transmission information as mutual information (I(X,Y)=H(X)+H(Y)−H(X,Y)≥0) may be saved when the plurality of transmitters (source X and source Y) transmit information at the joint entropy (H(X,Y)) rate, compared to when each encoder transmits information at an entropy rate. That is, the amount of transmitted information may be reduced.

In a legacy communication system, however, because information sources of a plurality of transmitters are regarded as having independent features, I(X, Y)=0 all the time, which means no correlation, and thus the resulting saving of transmitted information may not be considered. That is, when the communication system transmits information of independent sources and the receiver wants to perfectly recover all of the information, the amount of the transmitted information may not be reduced. When independent sources are assumed, the receiver may accurately recover signals transmitted from the plurality of transmitters based on individual encodings and joint decoding.

However, when only a specific function value for information sources is calculated without the need for recovering all of raw data as transmitted data, transmission may be performed based on an Orlitsky-Roch bound, as illustrated in FIG. 4. The Orlitsky-Roch bound may represent the boundary of lossless coding or lossy coding with zero distortion for a given function.

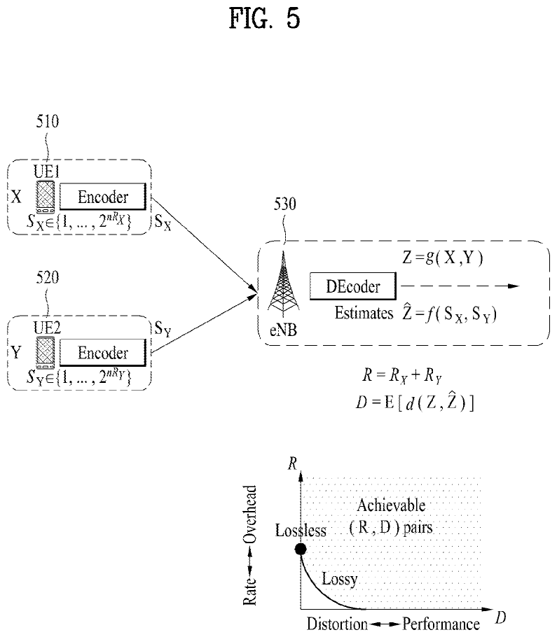

Referring to FIG. 5, for example, source coding schemes may be categorized into lossless source coding and lossy source coding. Lossless source coding is intended to allow a receiver to perfectly recover information transmitted from a transmitter without errors, whereas lossy source coding is intended for a required transmission rate, when a receiver considers a certain degree of distortion in information transmitted from a transmitter.

Referring to FIG. 5, a first UE (UE1) 510 and a second UE (UE2) 520 may transmit information to an eNB 530. The eNB 530 may determine the difference between an actually given function value Z and an estimate \hat{Z} obtained at a receiver to be loss. A rate distortion curve may represent a minimum required transmission rate, when distortion is considered in relation to the given function. That is, the rate distortion curve may represent a minimum required transmission rate, when distortion caused by source encoding/decoding is considered.

A typical feedback-based overhead-performance tradeoff may be evaluated by a rate distortion curve in lossy source coding. When the boundary of the rate distortion curve is approached, the transmission rate may be increased. That is, the amount of information to be transmitted may be reduced most at the boundary of the rate distortion curve. Accordingly, there may be a need for a source coding/decoding scheme for approaching the boundary of a rate distortion curve.

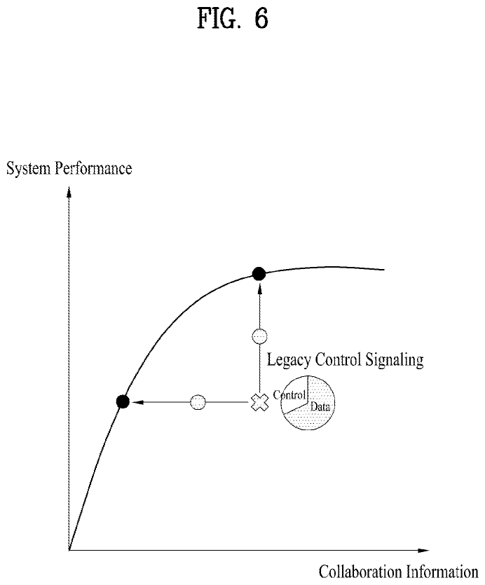

FIG. 6 is a diagram illustrating an achievable bound. A rate distortion curve may represent a minimum required transmission rate, when distortion is considered in relation to a given function, as described above.

Referring to FIG. 6, system performance may be represented as an achievable bound. A legacy transmitter performs transmission based on a value below a boundary region. In contrast, signal transmission may be performed based on a value in the boundary region in order to increase signal transmission efficiency and reduce transmission overhead. Accordingly, a practical source coding scheme that approaches the above-described boundary may be provided by minimizing distortion based on a given function as described above and applying a related distributed scalar quantizer.

For example, a Bayes estimator may be used to minimize distortion. More specifically, distortion may be analyzed by analyzing a specific function as a given function. An appropriate parameter of a quantizer that approaches an achievable bound on a curve in which the analyzed distortion is considered may be configured. Further, an encoding rule for the appropriate parameter may be applied. As such, a practical encoding method may be configured by analyzing the given function only once.

The effect of reducing feedback overhead may be achieved by setting a legacy feedback scheme in a given method.

For example, source coding suitable for distributed function computation may be layered architecture for multi-terminal source coding. Layered architecture for multi-terminal source coding is a mere appellation which should not be construed as limiting the present disclosure. The same configuration may be applied to the same method, and the present disclosure may not be limited to the foregoing embodiment.

Layered architecture for multi-terminal source coding (hereinafter, referred to as layered architecture) may include a fundamental limit for setting a boundary based on the information theory of distributed function computation in a search step. More specifically, as described above, it is necessary to determine a specific function in order to set an information theory bound. In this case, given a distributed function of interest to the receiver, the achievable bound of feedback transmission information, which represents a corresponding function value as minimal sufficient information may be analyzed.

For example, when the receiver recovers a function value represented as information sources transmitted by the independent transmitters, minimum encoding rates of the transmitters may be represented as a rate distortion region. In this case, the rate distortion curve may represent a minimum transmission rate required when the independent sources transmit information to the one receiver (e.g., central estimation officer). Therefore, how close the practical coding scheme is to the information theory boundary may be determined.

However, to obtain the achievable bound, it is necessary to minimize distortion according to a distortion measurement that is actually applied. For example, the distortion may be minimized through a B ayes detector.

An optimal distributed functional scalar quantizer may then be designed in consideration of the distortion.

For example, basically, a functional distributed quantizer that performs quantization at K levels based on continuous sources uniformly distributed between [0, 1] may be considered. In this case, a quantizer to be used in each UE may be configured based on a distortion measurement according to a given function. Intervals of the quantizers that minimize an applied average distortion may be obtained according to the relationship between the intervals of the quantizers of the UEs.

As described before, the distortion may be defined as loss caused by the difference between a given function value Z and an estimated value \hat{Z} at the receiver. To this end, the quantizers for transmitters i may be divided into K intervals based on Equation 1 below.

$${ϰ}_{i} = {⋃}_{{k}_{i} = 1}^{K} {I}_{i , {k}_{i}} , {I}_{i , {k}_{i}} = [ {l}_{i , {k}_{i} - 1} , {l}_{i , {k}_{i}} ] \qquad [ Equation 1 ]$$

The transmitters are K disjoint intervals, given as [l_{i,0},l_{i,1}), [l_{i,1},l_{i,2}), . . . , [l_{i,K-1},l_{i,K}]. Because continuous sources between [0, 1] are considered, l_{i,0}=inf Xᵢ=0 and l_{i,K}=sup Xᵢ=1 may be set. For them, the decision boundary is {lₖ}ₖ₌₀^{K} and the reconstruction level is {uₖ}ₖ₌₁^{K}. Each quantizer is used as an encoder, and the encoding rule may be given by Equation 2.

Qᵢ(xᵢ)=uₖ l_{i,k-1}≤xᵢ<l_{i,k} [Equation 2]

The decoder may perform decoding based on a Bayes detector. Considering a Bayes estimator that minimizes an average distortion, there is a need for considering distributed quantizers in a plurality of transmitters. Accordingly, the Bayes estimator may be configured according to Equation 3 by setting the plurality of transmitters and given indices to k=[k₁, . . . , k_{M}] and assuming interval thresholds l=[l_{i,k}|k∈{1, . . . , K}].

\hat{z}(k,l)=argmin_{\hat{z}}E[d(Z,\hat{z})|X₁∈Iₖ_{₁}, . . . ,X_{M}∈Iₖ_{_{M}}] [Equation 3]

The distortion of a distributed quantizer for a given interval threshold may not be observed in all regions. That is, distortion may be observed in a part overlapped between the intervals of the transmitters.

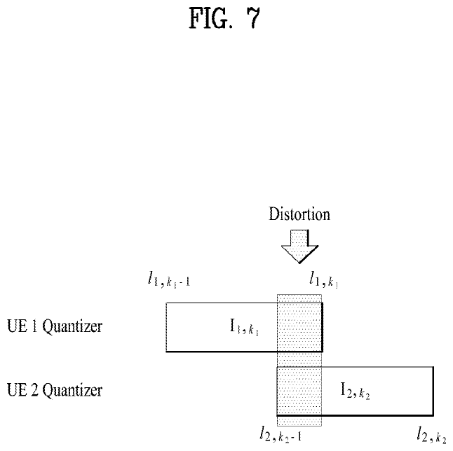

For example, it may be noted from FIG. 7 that for two transmitters (or two UEs), distortion in intervals with which to represent K levels is observed in a partial area. That is, the average distortion for the given quantization indices and the interval thresholds should be simplified in consideration of the part overlapped between the intervals. Therefore, the expected distortion of the Bayes estimator across the entire intervals is involved in the quantized levels and the distribution of the sources, and thus may be given as Equation 4.

$$D ( l ) = {\sum }_{k ∈ {\{ 1 , … , K \}}^{M}} E [ d ( Z , \hat{z} ( k , l ) ) \vert {X}_{1} ∈ {I}_{{k}_{1}} , … , {X}_{M} ∈ {I}_{{k}_{M}} ] {\prod }_{i = 1}^{M} P [ {X}_{i} ∈ {I}_{{k}_{i}} ] \qquad [ Equation 4 ]$$

It may be concluded that considering a K-level distributed function quantizer, Equation 5 should be satisfied to achieve minimized distortion.

$${D}_{K} = {min}_{l} D ( l ) \qquad [ Equation 5 ]$$

Since a K-level distributed functional quantizer minimizing the distortion of continuous sources uniformly distributed between [0, 1] has been considered, there is a need for scaling-based parameter remapping by reflecting statistics of information sources to be actually applied.

In this case, in consideration of a parameter configuration, the above calculated parameters may be applied to a feedback mechanism. For example, when the receiver is assumed to be an eNB and the transmitters are assumed to be individual UEs, an encoding/decoding configuration for each function of interest may be broadcast in system information by the eNB or preconfigured for the UEs. Thereafter, when distributed function computation is triggered according to a feedback mechanism, the eNB may broadcast a function index to be applied to the UEs in system information. When a heterogeneous distributed quantizer with a different encoding rule for each UE is applied, an encoding index for each UE may be transmitted by an additionally designated method, and the present disclosure is not limited to the above-described embodiment.

Thereafter, when a UE receives information about a function index and an encoding rule from the eNB, the UE transmits feedback information to the eNB by applying an encoding scheme for a corresponding function. When the eNB receives the feedback information from each UE, it may perform function value computation by applying a joint decoding rule.

In other words, after obtaining a rate distortion curve for a specific value of a given function and obtaining a distributed functional scalar quantizer for minimizing distortion, a signal may be transmitted by performing parameter configuration for a feedback mechanism.

### Embodiment 1

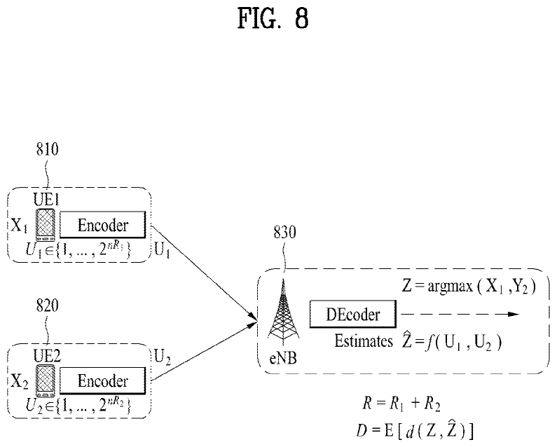

For a more specific embodiment, reference may be made to FIG. 8. Referring to FIG. 8, a channel quality indicator (CQI) reporting mechanism involving two UEs 810 and 820, and an eNB 830 may be considered. The two UEs 810 and 820 and the eNB 830 may perform a resource allocation procedure based on 4-bit LTE CQI feedback information. Regarding resource allocation, only resource allocation to a UE having the best channel needs to be determined, and an argmax function may be considered in the determination. Further, a max function which sets a threshold for a broadcast signal based on only the value of the best channel or a max & argmax function which applies adaptive modulation and coding to a UE having the best channel may be considered, and the present disclosure is not limited to the foregoing embodiment.

Further, an adaptive modulation and coding scheme (MCS) may be applied, in which an MCS index is allocated based on a CQI. That is, a given function may be set in the CQI feedback mechanism, and the present disclosure is not limited to the above embodiment. While the following description is given in the context of distributed function computation based on the argmax function that allocates resources offering the best channel to the UEs 810 and 820, it should not be construed as limiting the present disclosure.

Further, a different specific value may also be configured for the given function. For example, while the best channel is given as the specific value in the above description, a best CQI may be given as the specific value. Further, a best UE may be given as the specific value. That is, even the specific value may be set differently based on the given function, and the present disclosure is not limited to the above embodiment.

The eNB 830 may receive 4-bit CQIs measured by the UEs from the UEs in order to allocate DL resources to the UEs. Subsequently, the eNB 830 may allocate the resources to a UE having the best channel based on the CQIs. When the eNB 830 checks only the best channel, the eNB 830 has only to calculate an argmax value as a function for checking the UE having the best channel without recovering all of the CQIs which are raw data. That is, the eNB 830 has only to check values of the argmax function as the given function, and thus the afore-described distributed function computation scheme may be applied.

To apply distributed function computation as described before, a rate distortion region should be calculated. For example, feedback mechanism information for 4-bit CQIs may be listed in Table 1 below.

TABLE 1

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 376 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In Table 1, efficiency is a channel capacity (spectral efficiency), and for every CQI index X, information sources may be assumed to be uniformly distributed across 16 levels. When resources are allocated to a UE having the best channel based on the above table, distortion measurement may be defined as channel capacity loss (spectral efficiency loss) in consideration of efficiency by Equation 6 and Table 2.

d(Z,\hat{Z})=C[X_{Z}]−C[X_{\hat{Z}}] [Equation 6]

TABLE 2

| X | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| C(X) | 0 | 0.1523 | 0.2344 | 0.377 | 0.6016 | 0.877 | 1.1758 | 1.4766 | 1.9141 | 2.4083 | 2.7305 | 3.3223 | 3.9023 | 4.5224 | 5.1152 | 5.5547 |

Referring to FIG. 8, when the two UEs 810 and 820 transmit signals to the single eNB 830, a Bayes detector for a resource allocation function z=argmax(X₁,X₂) may be applied, The Bayes detector Q(\hat{z}|u₁,u₂) may be given by Equation 7.

$$Q ( \hat{z} \vert {u}_{1} , {u}_{2} ) = {argmin}_{\hat{z}} E [ d ( Z , \hat{z} ) \vert {U}_{1} = {u}_{1} {U}_{2} = {u}_{2} ] \\ A ( \hat{z} \vert {u}_{1} , {u}_{2} ) = {\sum }_{z} d ( z , \hat{z} ) P [ z \vert {U}_{1} = {u}_{1} {U}_{2} = {u}_{2} ] = {\sum }_{{x}_{1} , {x}_{2}} \{ C [ {x}_{argmax ( {x}_{1} , {x}_{2} )} ] - C [ {x}_{\hat{z}} ] \} P [ {x}_{1} , {x}_{2} \vert {U}_{1} = {u}_{1} {U}_{2} = {u}_{2} ] \\ A ( \hat{z} = 1 \vert {u}_{1} , {u}_{2} ) = {\sum }_{{x}_{1} , {x}_{2}} \{ C [ {x}_{argmax ( {x}_{1} , {x}_{2} )} ] - C [ {x}_{1} ] \} P [ {x}_{1} , {x}_{2} \vert {U}_{1} = {u}_{1} {U}_{2} = {u}_{2} ] \\ A ( \hat{z} = 2 \vert {u}_{1} , {u}_{2} ) = {\sum }_{{x}_{1} , {x}_{2}} \{ C [ {x}_{argmax ( {x}_{1} , {x}_{2} )} ] - C [ {x}_{2} ] \} P [ {x}_{1} , {x}_{2} \vert {U}_{1} = {u}_{1} {U}_{2} = {u}_{2} ] \\ A ( \hat{z} = 1 \vert {u}_{1} , {u}_{2} ) \begin{matrix}\hat{z} = 1 \\ < \\ > \\ \hat{z} = 2\end{matrix} A ( \hat{z} = 2 \vert {u}_{1} , {u}_{2} ) \\ {\sum }_{{x}_{1} , {x}_{2}} C [ {x}_{1} ] P [ {x}_{1} , {x}_{2} \vert {U}_{1} = {u}_{1} {U}_{2} = {u}_{2} ] \begin{matrix}\hat{z} = 1 \\ < \\ > \\ \hat{z} = 2\end{matrix} {\sum }_{{x}_{1} , {x}_{2}} C [ {x}_{2} ] P [ {x}_{1} , {x}_{2} \vert {U}_{1} = {u}_{1} {U}_{2} = {u}_{2} ] \\ {\sum }_{{x}_{1} , {x}_{2}} C [ {x}_{1} ] P [ {u}_{1} , {u}_{2} \vert {x}_{1} , {x}_{2} ] \frac{P ( {x}_{1} , {x}_{2} )}{P ( {u}_{1} , {u}_{2} )} \begin{matrix}\hat{z} = 1 \\ < \\ > \\ \hat{z} = 2\end{matrix} {\sum }_{{x}_{1} , {x}_{2}} C [ {x}_{2} ] P [ {u}_{1} , {u}_{2} \vert {x}_{1} , {x}_{2} ] \frac{P ( {x}_{1} , {x}_{2} )}{P ( {u}_{1} , {u}_{2} )} \\ {\sum }_{{x}_{1} , {x}_{2}} C [ {x}_{1} ] P [ {u}_{1} \vert {x}_{1} ] P ( {x}_{1} ) P [ {u}_{2} \vert {x}_{2} ] P ( {x}_{2} ) \begin{matrix}\hat{z} = 1 \\ < \\ > \\ \hat{z} = 2\end{matrix} {\sum }_{{x}_{1} , {x}_{2}} C [ {x}_{2} ] P [ {u}_{1} \vert {x}_{1} ] P ( {x}_{1} ) P [ {u}_{2} \vert {x}_{2} ] P ( {x}_{2} ) \qquad [ Equation 7 ]$$

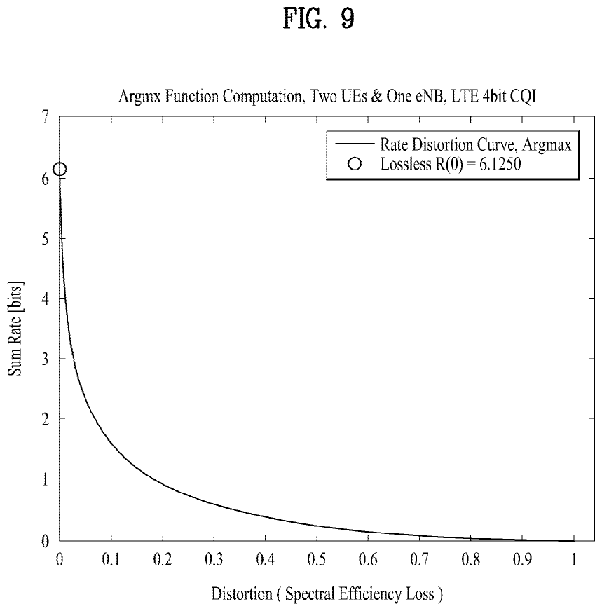

The argmax function may minimize distortion according to the above Bayes detector. As a result, the rate distortion curve may be produced as illustrated in FIG. 9.

Then, a K-level distributed functional quantizer that minimizes the distortion of continuous sources uniformly distributed between [0, 1] may first be considered. For the quantizer, a parameter may be obtained by scaling in a procedure for remapping to statistics of the information sources, and the above Bayes detector may be considered. Herein, a Bayes detector for a Z=Argmax(X₁,X₂) may be given by Equation 8.

$$\hat{Z} = \{ \begin{matrix}1 & {l}_{1 , {k}_{1} - 1} \geq {l}_{2 , {k}_{2}} \\ 2 & {l}_{2 , {k}_{2} - 1} \geq {l}_{1 , {k}_{1}} \\ {z}_{0}^{*} & max ( {l}_{2 , {k}_{2} - 1} , {l}_{1 , {k}_{1} - 1} ) \leq min ( {l}_{1 , {k}_{1}} , {l}_{2 , {k}_{2}} ) \leq max ( {l}_{1 , {k}_{1}} , {l}_{2 , {k}_{2}} )\end{matrix} \qquad [ Equation 8 ]$$

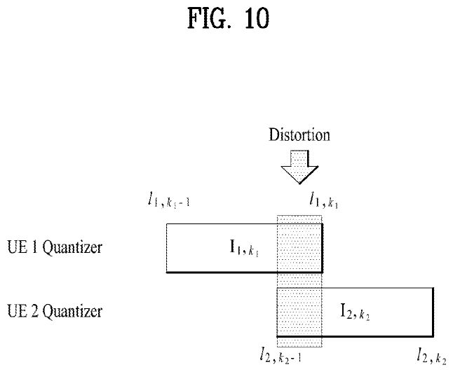

Herein, z*₀ is a detector that minimizes distortion in an overlapped part, as illustrated in FIG. 10, and may be expressed as Equation 9.

$${z}_{0}^{*} = \{ \begin{matrix}1 & E [ {X}_{1} \vert {X}_{1} ∈ {I}_{1 , {k}_{1}} ] \geq E [ {X}_{2} \vert {X}_{2} ∈ {I}_{2 , {k}_{2}} ] \\ 2 & E [ {X}_{1} \vert {X}_{1} ∈ {I}_{1 , {k}_{1}} ] < E [ {X}_{2} \vert {X}_{2} ∈ {I}_{2 , {k}_{2}} ]\end{matrix} \qquad [ Equation 9 ]$$

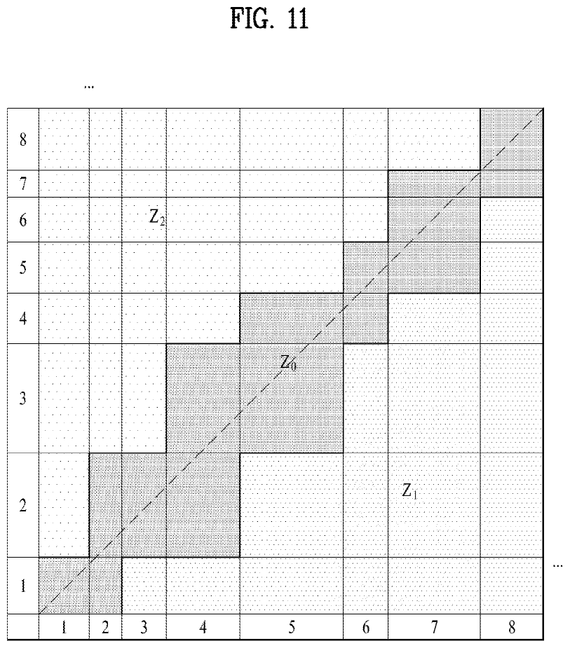

When this Bayes detector is used, the expected distortion occurs only in an overlapped part between I_{1,k}_{₁} and I_{2,k}_{₂}, as illustrated in FIG. 11.

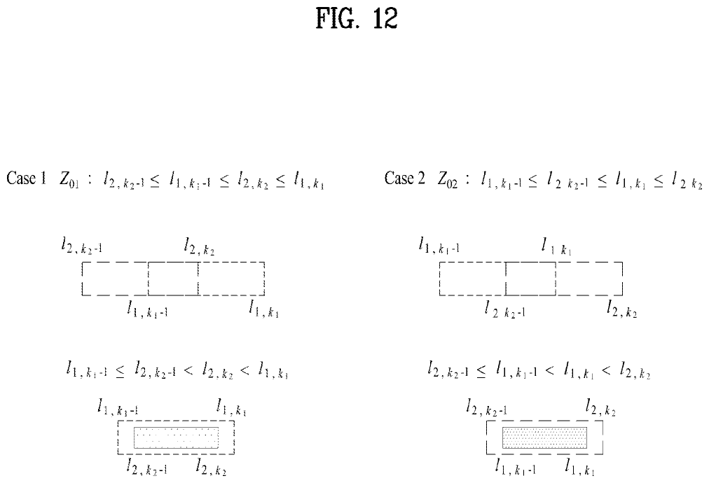

Accordingly, the expected distortion in the given intervals may be given by Equation 10, and cases of respective overlapped intervals may be represented as illustrated in FIG. 12. The expected distortion is given by Equation 11.

$$\begin{matrix}{argmin}_{\hat{z}} E [ d ( Z , \hat{z} ) \vert {X}_{1} ∈ {I}_{1 , {k}_{1}} , {X}_{2} ∈ {I}_{2 , {k}_{2}} ] = {argmin}_{\hat{z}} E [ {X}_{Z} - {X}_{z} {1}_{Z \geq \hat{Z}} \vert {X}_{1} ∈ {I}_{1 , {k}_{1}} , {X}_{2} ∈ {I}_{2 , {k}_{2}} ] \\ E [ {X}_{Z} \vert {X}_{1} ∈ {I}_{1 , {k}_{1}} , {X}_{2} ∈ {I}_{2 , {k}_{2}} ] - {argmin}_{\hat{z}} E [ {X}_{z} {1}_{Z \geq \hat{Z}} \vert {X}_{1} ∈ {I}_{1 , {k}_{1}} , {X}_{2} ∈ {I}_{2 , {k}_{2}} ] = {argmin}_{\hat{z}} E [ {X}_{z} {1}_{Z \geq \hat{Z}} \vert {X}_{1} ∈ {I}_{1 , {k}_{1}} , {X}_{2} ∈ {I}_{2 , {k}_{2}} ] & [ Equation 10 ] \\ E [ d ( Z , z ) ] = {\sum }_{\text{?}} \int \text{?} z [ {f}_{{x}_{1}} ( z ) [ {F}_{{X}_{1}} ( z ) - {F}_{{X}_{2}} ( {I}_{2 , {I}_{2} - 1} ) ] + [ {F}_{{x}_{1}} ( z ) - \\ {F}_{{x}_{1}} ( z ) {F}_{{x}_{1}} ( {l}_{1 , {k}_{1} - 1} ) ] {f}_{{X}_{1}} ( z ) ] dz + \\ {\sum }_{\text{?}} \int \text{?} {z}_{{f}_{{x}_{1}}} ( z ) dz [ {F}_{{X}_{1}} ( {I}_{2 , {k}_{1}} ) - {F}_{{X}_{1}} ( {I}_{2 , {k}_{2} - 1} ) ] \\ {\sum }_{\text{?}} max ( E [ {X}_{1} \vert {X}_{1} ∈ {I}_{1 , {k}_{1}} ] , E [ {X}_{2} \vert {X}_{2} ∈ {I}_{2} , {k}_{2} ] ) + \\ {\sum }_{\text{?}} \int \text{?} [ {f}_{{x}_{2}} ( z ) [ {F}_{{X}_{1}} ( z ) - {F}_{{X}_{1}} ( {I}_{2 , {k}_{1} - 1} ) ] + [ {F}_{{x}_{2}} ( z ) - \\ {F}_{{x}_{1}} ( z ) {F}_{{x}_{1}} ( {l}_{2 , {k}_{2} - 1} ) ] {f}_{{X}_{1}} ( z ) ] dz + \\ {\sum }_{\text{?}} \int \text{?} {zf}_{{x}_{1}} ( z ) dz [ {F}_{{X}_{1}} ( {I}_{1 , {k}_{1}} ) - {F}_{{X}_{1}} ( {I}_{1 , {k}_{1} - 1} ) ] + \\ {\sum }_{\text{?}} max ( E [ {X}_{1} \vert {X}_{1} ∈ {I}_{1 , {k}_{1}} ] , E [ {X}_{2} \vert {X}_{2} ∈ {I}_{2} , {k}_{2} ] ) \\ \text{?} \text{indicates text missing or illegible when filed} & [ Equation 11 ]\end{matrix}$$

Referring to FIG. 12, considering E[X_{\hat{z}}1_{Z≥\hat{Z}}|X₁∈I_{1,k}_{₁},X₂∈I_{2,k}_{₂}] belonging to Z₀₁ in case 1, the cumulative distribution function (CDF) of Event {t|X₁∈I_{1,k}_{₁},X₂∈I_{2,k}_{₂}} may be obtained by Equation 12. Herein, t=X_{z}, \hat{t}=X_{\hat{z}}.

$$[ Equation 12 ]$$

$${F}_{T \vert {X}_{1} ∈ {I}_{1 , {k}_{1}} , {X}_{2} ∈ {I}_{2 , {k}_{2}}} ( t ) = {F}_{{X}_{1} \vert {X}_{1} ∈ {I}_{1 , {k}_{1}}} ( t ) {F}_{{X}_{2} \vert {X}_{2} ∈ {I}_{2} , {k}_{2}} ( t ) = \{ \begin{matrix}0 & t < max ( {l}_{1 , {k}_{1} - 1} , {l}_{2 , {k}_{2} - 1} ) \\ {F}_{{X}_{1} \vert {X}_{1} ∈ {I}_{1 , {k}_{1}}} ( t ) {F}_{{X}_{2} \vert {X}_{2} ∈ {I}_{2} , {k}_{2}} ( t ) & max ( {l}_{1 , {k}_{1} - 1} , {l}_{2 , {k}_{2} - 1} ) \leq t \leq {l}_{2 , {k}_{2}} \\ {F}_{{X}_{1} \vert {X}_{1} ∈ {I}_{1 , {k}_{1}}} ( t ) & {l}_{2 , {k}_{2}} \leq t < {l}_{1 , {k}_{1}} \\ 1 & {l}_{1 , {k}_{1}} \leq t\end{matrix}$$

Further, the probability density function (PDF) of Event {t|X₁∈I_{1,k}_{₁},X₂∈I_{2,k}_{₂}} may be obtained by Equation 13.

$${f}_{T \vert {X}_{1} ∈ {I}_{1 , {k}_{1}} , {X}_{2} ∈ {I}_{2 , {k}_{2}}} ( z ) = \{ \begin{matrix}0 & t < max ( {l}_{1 , {k}_{1} - 1 , {l}_{2 , {k}_{2} - 1}} ) \\ \begin{matrix}{f}_{{X}_{1} \vert {X}_{1} ∈ {I}_{1 , {k}_{1}}} ( t ) {F}_{{X}_{2} \vert {X}_{2} ∈ {I}_{2 , {k}_{2}}} ( t ) + \\ {F}_{{X}_{1} \vert {X}_{1} ∈ {I}_{1 , {k}_{1}}} ( t ) + {f}_{{X}_{2} \vert {X}_{2} ∈ {I}_{2 , {k}_{2}}} ( t )\end{matrix} & max ( {l}_{1 , {k}_{1} - 1} , {l}_{2 , {k}_{2} - 1} ) \leq t \leq {l}_{2 , {k}_{2}} \\ {f}_{{X}_{1} \vert {X}_{1} ∈ {I}_{1 , {k}_{1}} ( t )} & {l}_{2 , {k}_{2}} \leq t < {l}_{1 , {k}_{1}} \\ 0 & {l}_{1 , {k}_{1}} \leq t\end{matrix} = \{ \begin{matrix}0 & t < max ( {l}_{1 , {k}_{1} - 1 , {l}_{2 , {k}_{2} - 1}} ) \\ \frac{\begin{matrix}{f}_{{X}_{1}} ( t ) [ {F}_{{X}_{2}} ( t ) - {F}_{{X}_{2}} ( {l}_{2 , {k}_{2} - 1} ) ] + \\ {f}_{{X}_{2}} ( t ) [ {F}_{{X}_{1}} ( t ) - {F}_{{X}_{1}} ( {l}_{1 , {k}_{1} - 1} ) ]\end{matrix}}{\begin{matrix}[ {F}_{{X}_{2}} ( {l}_{1 , {k}_{1}} ) - {F}_{{X}_{2}} ( {l}_{2 , {k}_{2} - 1} ) ] \\ [ {F}_{{X}_{2}} ( {l}_{2 , {k}_{2}} ) - {F}_{{X}_{2}} ( {l}_{2 , {k}_{2} - 1} ) ]\end{matrix}} & max ( {l}_{1 , {k}_{1} - 1} , {l}_{2 , {k}_{2} - 1} ) \leq t \leq {l}_{2 , {k}_{2}} \\ \frac{{f}_{{X}_{1}} ( t )}{{F}_{{X}_{1}} ( {l}_{1 , {k}_{1}} ) - {F}_{{X}_{1}} ( {l}_{1 , {k}_{1} - 1} )} & {l}_{2 , {k}_{2}} \leq t < {l}_{1 , {k}_{1}} \\ 0 & {l}_{1 , {k}_{1}} \leq t\end{matrix} \qquad [ Equation 13 ]$$

Further, in consideration of {t1_{T≥\hat{T}}|X₁∈I_{1,k}_{₁},X₂∈I_{2,k}_{₂}}. Equation 14 may be given.

$${argmax}_{\hat{z}} E [ {X}_{\hat{z}} {1}_{Z \geq \hat{Z}} \vert {X}_{1} ∈ {I}_{1 , {k}_{1}} , {X}_{2} ∈ {I}_{2 , {k}_{2}} ] = {argmax}_{\hat{t}} \hat{t} P [ T \geq t \vert {X}_{1} ∈ {I}_{1 , {k}_{1}} , {X}_{2} ∈ {I}_{2 , {k}_{2}} ] = {argmax}_{\hat{t}} [ 1 - {F}_{T \vert {X}_{1} ∈ {I}_{1 , {k}_{1}} , {X}_{2} ∈ {I}_{2 , {k}_{2}}} ( \hat{t} ) ] = {argmax}_{\hat{t}} \{ \begin{matrix}\hat{t} & t < max ( {l}_{1 , {k}_{1} - 1} , {l}_{2 , {k}_{2} - 1} ) \\ \hat{t} [ 1 - {F}_{{X}_{1} \vert {X}_{1} ∈ {I}_{1} , {k}_{1}} ( \hat{t} ) {F}_{{X}_{2} \vert {X}_{2} ∈ {I}_{2 , {k}_{2}}} ( \hat{t} ) ] & max ( {l}_{1 , {k}_{1} - 1} , {l}_{2 , {k}_{2} - 1} ) \leq t \leq {l}_{2 , {k}_{2}} \\ \hat{t} [ 1 - {F}_{{X}_{1} \vert {X}_{1} ∈ {I}_{1 , {k}_{1}}} ( \hat{t} ) ] & {l}_{2 , {k}_{2}} \leq t < {l}_{1 , {k}_{1}} \\ 0 & {l}_{1 , {k}_{1}} \leq t\end{matrix} = {argmax}_{\hat{t}} \{ \begin{matrix}\hat{t} & t < max ( {l}_{1 , {k}_{1} - 1} , {l}_{2 , {k}_{2} - 1} ) \\ \hat{t} [ 1 - {F}_{{X}_{1} \vert {X}_{1} ∈ {I}_{1} , {k}_{1}} ( \hat{t} ) {F}_{{X}_{2} \vert {X}_{2} ∈ {I}_{2 , {k}_{2}}} ( \hat{t} ) ] & max ( {l}_{1 , {k}_{1} - 1} , {l}_{2 , {k}_{2} - 1} ) \leq t \leq {l}_{2 , {k}_{2}} \\ \frac{\hat{t} [ {F}_{{X}_{1}} ( {l}_{1 , {k}_{1}} ) - {F}_{{X}_{1}} ( \hat{t} ) ]}{{F}_{{X}_{1}} ( {l}_{1 , {k}_{1}} ) - {F}_{{X}_{1}} ( {l}_{1 , {k}_{1} - 1} )} & {l}_{2 , {k}_{2}} \leq t < {l}_{1 , {k}_{1}} \\ 0 & {l}_{1 , {k}_{1}} \leq t\end{matrix} \qquad [ Equation 14 ]$$

The average distortion may be obtained based on

$${f}_{{X}_{i}} ( {x}_{i} ) = \{ \begin{matrix}1 & 0 \leq {x}_{i} \leq 1 \\ 0 & otherwise\end{matrix} {F}_{{X}_{i}} ( {x}_{i} ) = \{ \begin{matrix}0 & {x}_{i} < 0 \\ {x}_{i} & 0 \leq {x}_{i} \leq 1 \\ 1 & {x}_{i} > 1\end{matrix}$$

### by Equation 15.

$$[ \frac{2}{3} {t}^{3} - \frac{1}{2} ( {l}_{1 , {k}_{1} - 1} + {l}_{2 , {k}_{2} - 1} ) {t}^{2} ] {\vert}_{m ax ( {l}_{1 , {k}_{1} - 1} , {l}_{2 , {k}_{2} - 1} )}^{{l}_{2 , {k}_{2}}} + \frac{1}{2} ( {l}_{2 , {k}_{2}} - {l}_{2 , {k}_{2} - 1} ) {t}^{2} {\vert}_{{l}_{2 , {k}_{2}}}^{{l}_{1 , {k}_{1}}} - \frac{1}{2} ( {l}_{1 , {k}_{1}} - {l}_{1 , {k}_{1} - 1} ) ( {l}_{2 , {k}_{2}} - {l}_{2 , {k}_{2} - 1} ) max ( {l}_{1 , {k}_{1}} + {l}_{1 , {k}_{1} - 1} , {l}_{2 , {k}_{2}} + {l}_{2 , {k}_{2} - 1} ) \qquad [ Equation 15 ]$$

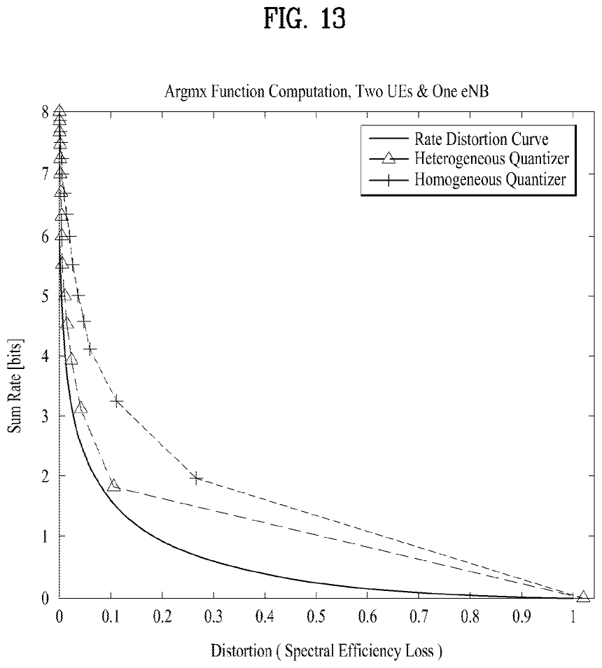

Likewise, in case 2 of region Z₀₂, when intervals are determined, the average distortion may be obtained by Equation 16 and the expected distortion may be obtained by Equation 17. The distorted distortion may be numerically optimized to obtain optimal quantized levels, as illustrated in FIG. 13.

$$\begin{matrix}[ \frac{2}{3} {t}^{3} - \frac{1}{2} ( {l}_{1 , {k}_{1} - 1} + {l}_{2 , {k}_{2} - 1} ) {t}^{2} ] {\vert}_{m ax ( {l}_{1 , {k}_{1} - 1} , {l}_{2 , {k}_{2} - 1} )}^{{l}_{1 , {k}_{1}}} + \frac{1}{2} ( {l}_{1 , {k}_{1}} - {l}_{1 , {k}_{1} - 1} ) {t}^{2} {\vert}_{{l}_{1 , {k}_{1}}}^{{l}_{2 , {k}_{2}}} - \frac{1}{2} ( {l}_{1 , {k}_{1}} - {l}_{1 , {k}_{1} - 1} ) ( {l}_{2 , {k}_{2}} - {l}_{2 , {k}_{2} - 1} ) max ( {l}_{1 , {k}_{1}} + {l}_{1 , {k}_{1} - 1} , {l}_{2 , {k}_{2}} + {l}_{2 , {k}_{2} - 1} ) & [ Equation 16 ] \\ E [ D [ T , \hat{T} ] ] = E [ E [ D ( T , \hat{T} ) \vert {U}_{1} , {U}_{2} ] ] = {\sum }_{( {k}_{1} , {k}_{2} ) ∈ {T}_{0}} E [ T - \hat{T} \vert {X}_{1} ∈ {I}_{1 , {k}_{1}} , {X}_{2} ∈ {I}_{2 , {k}_{2}} ] P [ {X}_{1} ∈ {I}_{1 , {k}_{1}} , {X}_{2} ∈ {I}_{2 , {k}_{2}} ] & [ Equation 17 ]\end{matrix}$$

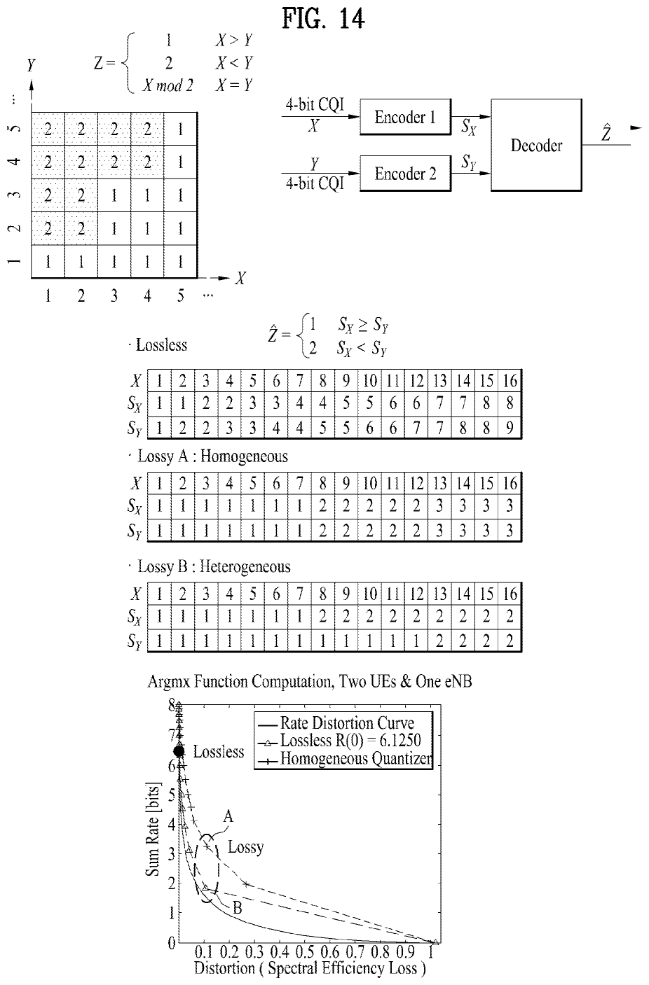

The above result may be the result of matching performed in consideration of distortion through continuous sources between [0, 1] and scaling based on CQI statistics defined as 16-level spectral efficiencies. A distributed functional quantizer may be configured from quantizer levels at lossless points, as illustrated in FIG. 14. When a heterogeneous distributed quantizer with a different encoding rule for each UE is applied, encoding index information for each UE may be transmitted in an additionally indicated method. For example, because a suitable lossless point is achieved by a heterogenous distributed quantizer in FIG. 14, specific encoding information for each UE may be provided.

Subsequently, a CQI feedback mechanism may be performed based on parameters derived based on the above description. When the eNB is to trigger resource allocation by argmax function computation, the eNB may designate the index of a preconfigured argmax function and a distributed quantizer encoding index for each UE or transmit the indexes to the UE in system information. Upon receipt of the function index and encoding index from the eNB, the UE may transmit a signal to the eNB by applying an encoding scheme for the function. When receiving a feedback mechanism from each UE, the eNB may perform function value computation by applying a joint decoding rule, and the present disclosure is not limited to the above embodiment.

### Embodiment 2

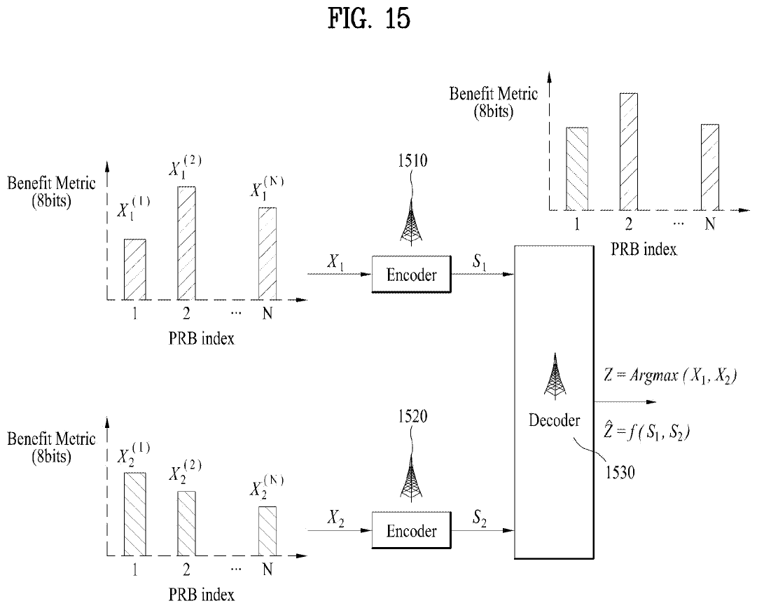

In another example, FIG. 15 illustrates an X2 interface for communication between eNBs in a CoMP environment. Referring to FIG. 15, eNBs 1510 and 1520 participating in CoMP should transmit, to a coordinate eNB 1530, benefit metrics allocated as values between −101 and 100 calculated based on reference signal received power (RSRP) and CQI combinations received from a UE, on a PRB basis. The foregoing argmax function may be given and the specific value may be a benefit metric for each PRB.

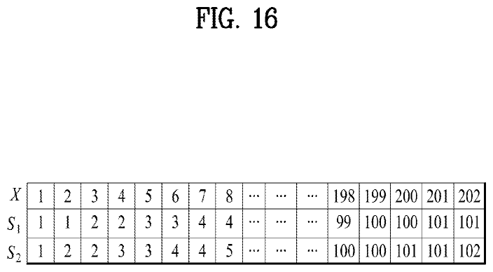

Upon receipt of metrics for each PRB from the eNBs 1510 and 1520, the coordinate eNB 1530 may determine an eNB to which a corresponding PRB is actually to be allocated by the argmax function. The coordinate eNB 1530 may transmit a PRB-wise bitmap to the eNBs 1510 and 1520. As in the foregoing embodiment, the coordinate eNB 1530 may calculate a rate distortion curve based on the argmax function. Then, distortion may be minimized by a suitable distributed functional quantizer. As described before, the quantizer may be obtained based on a Bayes detector, as illustrated in FIG. 16. The coordinate eNB 1530 may then set and update parameters and transmit the information to the eNBs 1510 and 1520. More specifically, a parameter configuration may be performed by applying a benefit metric reporting mechanism procedure based on the above calculated parameters. A rule of allocating each PRB at the coordinate eNB 1530 has already been determined to be argmax function computation. Thus, the index of the argmax function and a distributed quantizer encoding index for each eNB may be set and indicated.

The individual eNBs 1510 and 1520 transmit feedback information to the coordinate eNB 1530 by applying a corresponding encoding scheme for the argmax function. Upon receipt of the feedback information from the respective eNBs 1510 and 1520, the coordinate eNB 1530 may perform argmax function value computation by applying a joint decoding rule.

### Embodiment 3

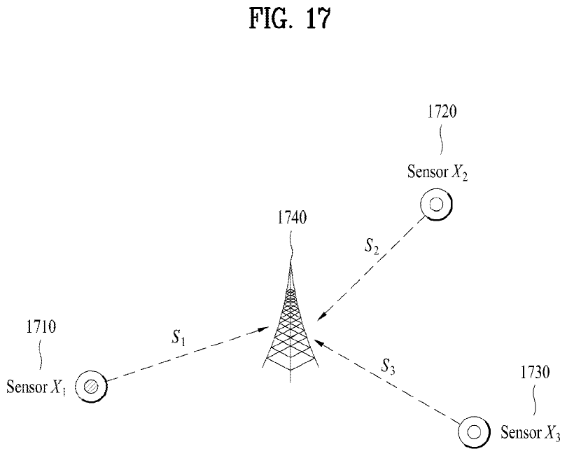

Referring to FIG. 17, the above-described configuration may be applied to an environment with a plurality of sensors in another example. More specifically, referring to FIG. 17, there may be a plurality of sensors 1710, 1720, and 1730 and a device 1740 which receives reports from the sensors. For example, the reported device 1740 may be, but not limited to, an eNB, a UE, or any other device. For example, the plurality of sensors 1710, 1720, and 1730 may be used for, but not limited to, fire detection or intrusion detection. In another example, the plurality of sensors 1710, 1720, and 1730 may be sensing devices at fixed positions.

For example, 16-level sensing values may be defined as in the above-described LTE CQI reporting. However, other numbers of levels may be determined in another reporting method, and the present disclosure is not limited thereto. The plurality of sensors 1710, 1720, and 1730 may report sensing values periodically to the reported device 1740. The reported device 1740 may detect sensed information from the reported values and transmit minimum information for this.

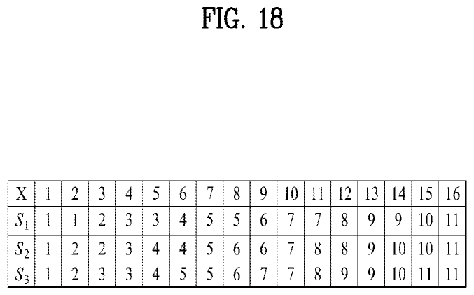

For example, when a given function is an argmax function and a sensing value is set as a specific value based on the argmax function, a rate distortion curve for the plurality of sensors 1710, 1720, and 1730 may be calculated. Subsequently, distortion may be minimized by a suitable distributed functional quantizer. As described before, a quantizer may be obtained based on a Bayes detector, as illustrated in FIG. 18. A parameter configuration may then be performed by applying sensing values based on calculated parameters.

The parameter configuration may be performed by a reporting mechanism procedure based on the above-described parameters. The reported device 1740 may set and indicate the index of a sensing value and a distributed quantizer encoding index for each of the sensors 1710, 1720, and 1730. The individual sensors 1710, 1720, and 1730 may transmit information to the reported device 1750 by applying a corresponding encoding scheme for the argmax function, and the present disclosure is not limited to the foregoing embodiment.

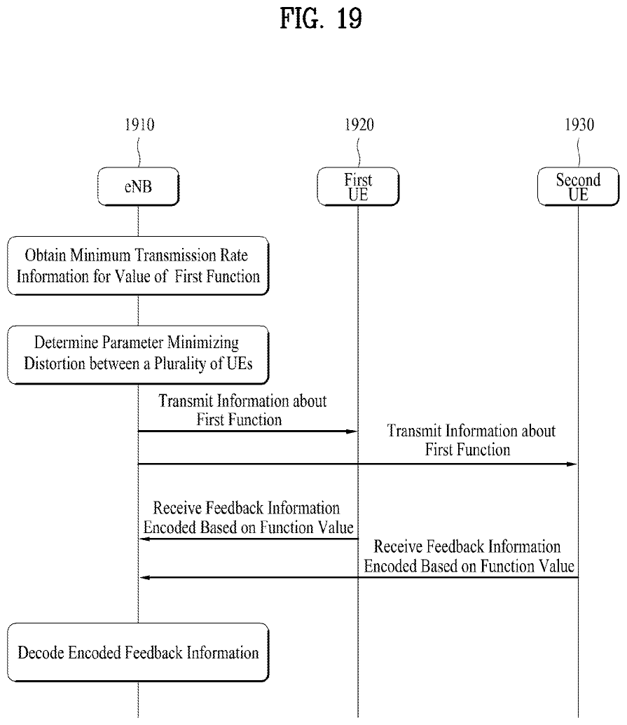

FIG. 19 is a diagram illustrating a signal flow for a method of receiving information at an eNB.

As described before, when the eNB estimates only a specific value of a given function without recovering all of raw data received from UEs, the amount of transmitted information may be reduced based on suitable source coding.

More specifically, referring to FIG. 19, an eNB 1910 may obtain minimum transmission rate information for a function value of a first function. The minimum transmission rate information may be information about a rate distortion curve as described before. That is, the minimum transmission rate information may be information about a curve representing minimal sufficient information for the function value of the first function of interest at the eNB 1910 as a receiver.

The rate distortion curve may be determined based on distortion, as described before. To minimize transmitted information based on the rate distortion curve, it is necessary to set an encoding rate in a boundary region. That is, a suitable source coding scheme may be applied to represent a minimum transmission rate in consideration of distortion, as described before.

The eNB 1910 may obtain and apply a Bayes detector to minimize distortion according to a distortion measurement. For example, quantizers may be configured for use in UEs 1920 and 1930 that transmit information to the eNB 1910. Distortion information may be obtained in consideration of the relationship between the intervals of the quantizers of the UEs 1920 and 1930, and the distortion may be minimized accordingly, as described before. Subsequently, the eNB 1910 may determine a parameter that minimizes distortion. That is, a parameter applied to encoding may be determined in consideration of the function value of the first function.

The eNB 1910 may transmit function index information and encoding index information as information about the first function to the first UE 1920 and the second UE 1930. While two UEs and one eNB are shown in FIG. 19, the same thing may be applied to a case in which more UEs exist, and the present disclosure is not limited to the foregoing embodiment.

Subsequently, the eNB 1910 may receive feedback information encoded based on the function value from the first UE 1920 and the second UE 1930. The UEs 1910 and 1920 may encode the feedback information through the above-descried quantizers. The eNB 1910 may decode the encoded feedback information based on the Bayes detector. That is, the eNB 1910 may control a parameter such that the quantizers may be decoded based on the Bayes detector, and indicate the controlled parameter to the UEs 1920 and 1930. Thus, the UEs 1920 and 1930 may reduce the amounts of transmitted information based on the parameter.

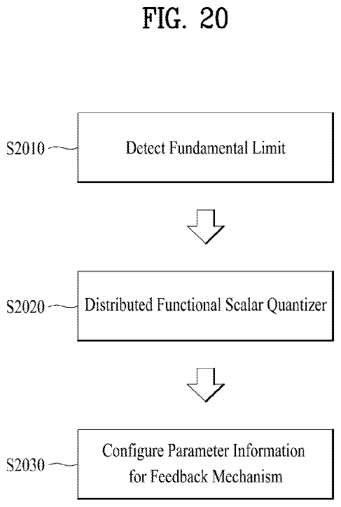

FIG. 20 is a flowchart illustrating a layered architecture for multi-terminal source coding scheme. As described before, a suitable source coding scheme for the case of a plurality of transmitters and one receiver may be layered architecture for multi-terminal source coding. Layered architecture for multi-terminal source coding is a mere appellation, to which the present disclosure is not limited. The same configuration may be applied to the same method, and the present disclosure is not limited to the present disclosure.

The layered architecture for multi-terminal source coding may include detecting a fundamental limit for setting an information theory bound of distributed function computation (S2010). More specifically, a specific function may be determined to set the bound, as described before. Once a function of interest for the receiver is determined, an achievable bound of feedback transmission information represented as minimal sufficient information that minimizes a corresponding function value may be analyzed. For example, when the receiver recovers a function value expressed as information sources transmitted by independent transmitters, minimum encoding rates of the receivers may be shown as a rate distortion region. Because a rate distortion curve represents minimum transmission rates required for independent sources to transmit information to one receiver (e.g., central estimation officer), the rate distortion curve may show how close a suitable coding scheme is to a bound. However, to obtain an achievable rate region, it is necessary to minimize distortion according to an actually applied distortion measurement. For example, the distortion may be minimized by the afore-described Bayes detector.

A suitable distributed functional scalar quantizer may then be designed in consideration of the distortion (S2020). As described before, the distortion may be minimized in consideration of the relationship between the intervals of the quantizers at the transmitters. The quantizer may be configured based on the Bayes detector.

Subsequently, parameter information for a feedback mechanism may be configured (S2030). The parameter information may be transmitted to each UE, as described before. After the eNB transmits the parameter information to each transmitter, the transmitter may transmit feedback information encoded based on a parameter value to the eNB. The eNB may then decode the encoded feedback information, as described before.

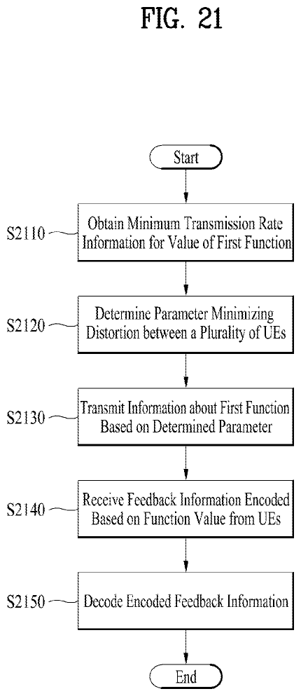

FIG. 21 is a flowchart illustrating a method of receiving information by an eNB.

Referring to FIG. 21, a receiver may acquire minimum transmission rate information for a function value of a first function (S2110). As described before with reference to FIGS. 1 to 20, the minimum transmission rate information may be determined based on a rate distortion curve. The rate distortion curve is configured in consideration of distortion of a plurality of transmitters, representing minimum transmission rates.

The receiver may then determine a parameter that minimizes the distortion between the plurality of UEs (S2120). As described before with reference to FIGS. 1 to 20, a distributed functional scalar quantizer may then be designed to minimize the distortion in consideration of quantizers at the respective transmitters and the relationship between the intervals of the quantizers. The receiver may determine a parameter that minimizes the distortion based on the distributed functional scalar quantizer, as described before.

The receiver may then transmit information about the first function based on the determined parameter to the receiver (S2130). For example, the receiver may be a UE. Further, as described before with reference to FIGS. 1 to 20, the information about the first function may include at least one of a function index or an encoding index. That is, the receiver may transmit information about the function and information about encoding to the plurality of transmitters, as described before.

The receiver may then receive feedback information encoded based on a function value from the plurality of transmitters (S2140). The plurality of transmitters may be UEs. As described before with reference to FIGS. 1 to 20, the plurality of transmitters may encode the feedback information by using quantizer information as a parameter, as described before.

The receiver may decode the encoded feedback information (S2150). As described before with reference to FIGS. 1 to 20, the encoded feedback information may be decoded through a Bayes detector. That is, the receiver may provide parameter information about encoding and decoding in consideration of distortion to the plurality of transmitters, and receive and decode information from the plurality of transmitters. In this manner, the amount of information transmitted by the plurality of transmitters may be reduced.

In the above, a transmitter may be a UE, an eNB, a sensor, or any other device. A receiver may also be an eNB, a UE, or any other device. That is, when a plurality of devices transmit signals to one device, one of the two parties may be configured as a transmitter and the other party may be configured as a receiver, and the present disclosure is not limited to the foregoing embodiment.

The embodiments of the present disclosure may be implemented through various means. For example, the embodiments may be implemented by hardware, firmware, software, or a combination thereof.

When implemented by hardware, a method according to examples of the present disclosure may be embodied as one or more application specific integrated circuits (ASICs), one or more digital signal processors (DSPs), one or more digital signal processing devices (DSPDs), one or more programmable logic devices (PLDs), one or more field programmable gate arrays (FPGAs), a processor, a controller, a microcontroller, a microprocessor, etc.

When implemented by firmware or software, a method according to examples of the present disclosure may be embodied as an apparatus, a procedure, or a function that performs the functions or operations described above. Software code may be stored in a memory unit and executed by a processor. The memory unit is located at the interior or exterior of the processor and may transmit and receive data to and from the processor via various known means.

As described above, the detailed description of the preferred examples of the present disclosure has been given to enable those skilled in the art to implement and practice the disclosure. Although the disclosure has been described with reference to exemplary embodiments, those skilled in the art will appreciate that various modifications and variations can be made in the present disclosure without departing from the spirit or scope of the disclosure described in the appended claims. Accordingly, the disclosure should not be limited to the specific examples described herein, but should be accorded the broadest scope consistent with the principles and novel features disclosed herein.

Reference is made herein to both apparatus and method inventions, and the descriptions of both apparatus and method inventions may be complementary to each other.

### INDUSTRIAL APPLICABILITY

The present disclosure is applicable to various wireless communication systems including systems conforming to IEEE 802.16x and IEEE 802.11x as well as 3GPP LTE and LTE-A systems.

What is claimed is:

1. A method of receiving information by a base station (BS) in a wireless communication system, the method comprising:
obtaining minimum transmission rate information for a function value of a first function;
determining a parameter minimizing distortion between a plurality of user equipments (UEs);
transmitting information about the first function based on the determined parameter to the plurality of UEs;
receiving feedback information encoded based on the function value from the plurality of UEs; and
decoding the encoded feedback information.

2. The method according to claim 1, wherein the minimum transmission rate information is determined based on a rate distortion curve.

3. The method according to claim 2, wherein when the plurality of UEs transmit the feedback information, the rate distortion curve is information on a minimum transmission rate for the function value of the first function in consideration of the distortion between the plurality of UEs.

4. The method according to claim 1, wherein the distortion between the plurality of UEs is minimized through a functional distributed quantizer.

5. The method according to claim 4, wherein when the functional distributed quantizer is applied, a quantizer is configured for use in each of the plurality of UEs, and the distortion is minimized in consideration of an interval of the quantizer configured in each of the plurality of UEs.

6. The method according to claim 5, wherein the feedback information is encoded based on the quantizer, and the encoded feedback information is decoded based on a Bayes detector.

7. The method according to claim 6, wherein the parameter is determined based on the quantizer.

8. The method according to claim 1, wherein the information about the first function includes at least one of a function index or an encoding index.

9. The method according to claim 1, wherein encoding and decoding configuration information for the first function is transmitted in system information to the plurality of UEs.

10. The method according to claim 1, wherein the feedback information is channel quality indicator (CQI) feedback information, and the first function is an argmax function.

11. A base station (BS) for receiving information in a wireless communication system, the BS comprising:
a reception module configured to receive a signal;
a transmission module configured to transmit a signal; and
a processor configured to control the reception module and the transmission module,
wherein the processor is configured to:
obtain minimum transmission rate information for a function value of a first function;
determine a parameter minimizing distortion between a plurality of user equipments (UEs);
transmit information about the first function based on the determined parameter to the plurality of UEs;
receive feedback information encoded based on the function value from the plurality of UEs; and
decode the encoded feedback information.

12. The BS according to claim 11, wherein the minimum transmission rate information is determined based on a rate distortion curve.

13. The BS according to claim 12, wherein when the plurality of UEs transmit the feedback information, the rate distortion curve is information on a minimum transmission rate for the function value of the first function in consideration of the distortion between the plurality of UEs.

14. The BS according to claim 11, wherein the distortion between the plurality of UEs is minimized through a functional distributed quantizer.

15. The BS according to claim 14, wherein when the functional distributed quantizer is applied, a quantizer is configured for use in each of the plurality of UEs, and the distortion is minimized in consideration of an interval of the quantizer configured in each of the plurality of UEs.

16. The BS according to claim 15, wherein the feedback information is encoded based on the quantizer, and the encoded feedback information is decoded based on a Bayes detector.

17. The BS according to claim 16, wherein the parameter is determined based on the quantizer.

18. The BS according to claim 11, wherein the information about the first function includes at least one of a function index or an encoding index.

19. The BS according to claim 11, wherein encoding and decoding configuration information for the first function is transmitted in system information to the plurality of UEs.

20. The BS according to claim 11, wherein the feedback information is channel quality indicator (CQI) feedback information, and the first function is an argmax function.
